(19) United States
(12) Patent Application Publication
(10) Pub. No.: US 2021/0031201 A1
(43) Pub. Date: Feb. 4, 2021

(54) DIFFERENTIAL PRESSURE ASSISTED DRAINAGE SYSTEM

(71) Applicant: Optofluidic Bioassay, LLC, Ann Arbor, MI (US)

(72) Inventors: Maung Kyaw Khaing Oo, Ann Arbor, MI (US); Xudong Fan, Saline, MI (US)

(21) Appl. No.: 17/046,040

(22) PCT Filed: Apr. 15, 2019
(86) PCT No.: PCT/US19/27439

§ 371 Date: Oct. 8, 2020

Related U.S. Application Data
(60) Provisional application No. 62/657,834, filed on Apr. 15, 2018.

(51) Int. Cl. B01L 3/00

(52) U.S. Cl. CPC B01L 3/502784; B01L 2200/027; B01L 2300/069; B01L 2400/049; B01L 2300/0829; B01L 2200/0621

(57) ABSTRACT

A drainage system and method for diagnostic systems and the like. The system comprises a base with a hinged lid. A plenum chamber is formed either in the base or the lid. When formed in the lid, the plenum chamber is configured to receive a positive pressure from a pneumatic pump. When formed in the base, the plenum chamber is configured to receive a negative pressure from a pneumatic pump. The base has an elevated table, from which an array of posts project. A semipermeable layer is placed on the truncated tips of the posts, and a microfluidic plate is set over the semipermeable layer. The lid is then closed to apply compression against the sandwiched plate and semipermeable layer. The pump is activated to establish a differential pressure through the plenum chamber, however the semipermeable layer provides pneumatic resistance to air flowing through the microfluidic channel(s) in the plate.

### CROSS REFERENCE TO RELATED APPLICATIONS

This application claims priority to Provisional Patent Application U.S. 62/657,834 filed on Apr. 15, 2018, the entire disclosure of which is hereby incorporated by reference and relied upon.

### BACKGROUND OF THE INVENTION

### Field of the Invention

The invention relates generally to measuring or testing systems and processes involving enzymes or microorganisms, and more particularly to drainage systems and drainage processes therefor.

### Description of Related Art

Nearly all microfluidic devices or units A have a liquid inlet 12 and a liquid outlet 13 that are connected via a microfluidic channel 16, as shown in FIGS. 1-2C. FIG. 1 is a simplified top view of an array of microfluidic units A on a chip, substrate or plate B. Typically, the microfluidic unit A is carried on or in a chip, substrate, or plate B supporting multiple microfluidic units A. In the example of FIG. 1, twelve microfluidic units A are carried on a common plate B. The spatial distance between two adjacent microfluidic units in the X-axis is represented by the dimensional variable X′. Similarly, the spatial distance between two adjacent microfluidic units in the Y-axis is represented by the dimensional variable Y′. These dimensional variables X′, Y′, as well as the number of microfluidic units A carried on a plate B are subject to designer and manufacturer preferences.

FIGS. 2A-C are highly-simplified side views of an array of microfluidic units A. The ambient surrounding 11 and the bottom plenum chamber 14 are separated. The pressure P₁ in a bottom plenum chamber 14 is lower than the pressure P₀ in the ambient surrounding (or ambient pressure), a condition generated by pulling or drawing the air out of the lower plenum chamber 14 through a vacuum system 15.

The microfluidic channel 16 can be a straight route or spiral or serpentine or any other suitable pattern. See for example US 2017/0097345 published Apr. 6, 2017, the entire disclosure of which is hereby incorporated by reference. When in use, a short segment of liquid will be carried along the microfluidic channel 16 moving in a direction from its associated inlet 12 toward its outlet 13. This liquid segment is often referred to as a liquid plug 17. Proper operation of a microfluidic device A depends on the efficient and successful movement of a liquid plug 17 through its microfluidic channel 16. Differential pressure is one of the most commonly used methods to drive the liquid plug 17 along a microfluidic channel 16. This usually involves creating the pressure difference between the inlet 12 and outlet 13—either in the form of a below-atmospheric pressure on the outlet 13 side (FIGS. 2A-C) or an above-atmospheric pressure on the inlet 12 side (FIGS. 6A-C) or a simple pressure differential un-related to ambient atmospheric conditions.

When multiple microfluidic units A co-exist on the same chip or plate B, as in the examples of FIGS. 1-2C and 6A-C, it will be observed that each unit A has its own liquid inlet 12 and outlet 13. In the example of FIG. 2A, the inlets 12 to four schematically-illustrated microfluidic units A are exposed to a relatively higher pressure P₀. The outlets 13 are commonly exposed to a relatively lower pressure P₁, where P₀ represents ambient atmospheric pressure. This pressure differential (P₀>P₁) motivates the liquid plugs 17 in each unit A to travel toward their respective outlets 13. Likewise, in the example of FIG. 6A, the inlets 12 to four schematically-illustrated microfluidic units A are exposed to a relatively higher pressure P₂ in a top plenum chamber 19. The outlets 13 are commonly exposed to a relatively lower pressure P₀, where P₀ again represents ambient atmospheric pressure. As in the previous example, the pressure differential (P₂>P₀) energizes the liquid plugs 17 in each unit A to travel toward their respective outlets 13.

However, when differential pressure is used to drive liquid plugs 17 through their respective channels 16, a problem may arise in instances where some but not all of the microfluidic units A on a common plate B are in use. This problem is illustrated in FIGS. 2B and 6B, in which the inlet 12 and the outlet 13 in the third unit A from the left becomes connected due to the absence of a liquid plug. FIGS. 2C and 6C also illustrate the problem via multiple units A absent a liquid plug 17. As a result, the microfluidic channel 16 for units without a plug 17 are open and the free-flow of air therethrough prohibits the proper formation of a pressure differential. Possible reasons for the absence of a liquid plug in any given particular unit include: (1) the particular unit(s) were not used at any time during the experimental procedure; and (2) the particular unit(s) were used however the liquid plug 17 came out (emptied) earlier than the plugs 17 in other units A. Regardless of the reason, the consequence of no liquid plug 17 in one (FIGS. 2B, 6B) or multiple (FIGS. 2C, 6C) units A is that the pressure at the inlet 12 and at the outlet 13 reaches equilibrium quickly for all remaining units A, causing all transiting liquid plug(s) 17 to stop flowing and to be trapped in their respective channels 16. The stagnation of one or more liquid plugs 17 is highly undesirable.

There is therefore a need in the art for improved methods and systems to drain microfluidic devices that will avoid the occurrence of stagnated liquid plugs 17.

### BRIEF SUMMARY OF THE INVENTION

This invention pertains to a method and a related drainage system to address the above problem so that the differential pressure can be maintained between the inlet and outlet regardless of whether there is the liquid plug in each microfluidic unit.

According to a first aspect of this invention, a drainage system is provided for prompting movement of at least one liquid plug through a microfluidic channel toward an outlet. The system comprises a base. A lid is operatively connected to the base. A plenum chamber is associated with one of the base and lid. A semipermeable layer is disposed between the base and the lid. The semipermeable layer is configured to provide pneumatic resistance to air flowing through the microfluidic channel.

According to a second aspect of this invention, a drainage system is provided for prompting movement of at least one liquid plug through a microfluidic channel toward an outlet. The system comprises a base. A lid is hingedly connected to the base for swinging movement between opened and closed positions. A plenum chamber is associated with one of the base and lid. A fitting extends from the plenum chamber. A hose is attached to the fitting. A pump is operatively connected to the hose for generating a negative and/or a positive pressure in the hose. A semipermeable layer is disposed between the base and the lid. The semipermeable layer is configured to provide pneumatic resistance to air flowing through the microfluidic channel.

According to a third aspect of this invention, a method is provided for draining a microfluidic device. The method includes the step of positioning a microfluidic well plate on a receiving table. The plate has at least one microfluidic unit. The unit includes an inlet and an outlet and a microfluidic channel that extends between the respective inlet and outlet. The method further includes generating a pressure differential in a plenum chamber located with respect to one of the inlet and outlet of the microfluidic unit. And also, the method includes pressing a semipermeable layer against the outlet to provide pneumatic resistance to air flowing through the microfluidic channel.

The systems and method of this invention provide convenient, reliable and cost effective ways to drive the liquid plugs through microfluidic units by differential pressure. The differential pressures can be generated by any convenient means and operated either through negative pressure (i.e., vacuum) or positive pressure.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a simplified top view of an array of microfluidic units supported on a common carrier plate;

FIGS. 2A-C are schematic diagrams of a prior art drainage system depicting three different operating conditions and wherein a vacuum drawn from bottom to establish a differential pressure;

FIGS. 3A-C are schematic diagrams comparable to FIGS. 2A-C however showing improved functionality in some operating conditions due to the inclusion of a semipermeable layer and wherein a vacuum drawn from a bottom plenum chamber establishes a differential pressure;

FIG. 4A is a schematic diagram of a drainage system in an alternative embodiment incorporating a relatively thin semipermeable layer having dense porous regions surrounded by loose porous regions and wherein a vacuum drawn from a bottom plenum chamber establishes a differential pressure;

FIG. 4B is a schematic diagram as in FIG. 4A, but showing an alternative embodiment in which the semipermeable layer is relatively thick;

FIG. 5 illustrates yet another alternative embodiment in which a higher density region is created by localized compression of the semipermeable layer using a post feature;

FIGS. 6A-C are schematic diagrams of a prior art drainage system depicting three different operating conditions and wherein a positive pressure is introduced from a top plenum chamber to establish a differential pressure;

FIGS. 7A-C are schematic diagrams comparable to FIGS. 6A-C however showing improved functionality in some operating conditions due to the inclusion of a semipermeable layer and wherein a positive pressure is introduced from a top plenum chamber to establish a differential pressure;

FIG. 8A is a top view of a drainage device showing the lid in a closed condition according to one embodiment of the present invention;

FIG. 8B shows a bottom view of the drainage device of FIG. 8A;

FIG. 8C is a front elevational view of the drainage device of FIG. 8A;

FIG. 8D is a right-side elevational view of the drainage device of FIG. 8A;

FIG. 8E is an isometric view of the drainage device of FIG. 8A;

FIG. 8F is a cross-sectional view taken generally along lines 8F-8F in FIG. 8A;

FIG. 9 an isometric view of the drainage device as in FIG. 8E but showing the lid in an open condition with a microfluidic plate and semipermeable layer in exploded form, and further showing an operatively connected pneumatic pump,

FIG. 10A is an enlarged fragmentary view of an exemplary microfluidic plate for use in the drainage system and method of this invention;

FIG. 10B is a cross-sectional view taken transversely through the base of a drainage device like that shown in FIG. 8E; and

FIG. 11 is a perspective view as in FIG. 9 but with an exemplary plate and semipermeable layer disposed in operative positions upon the base.

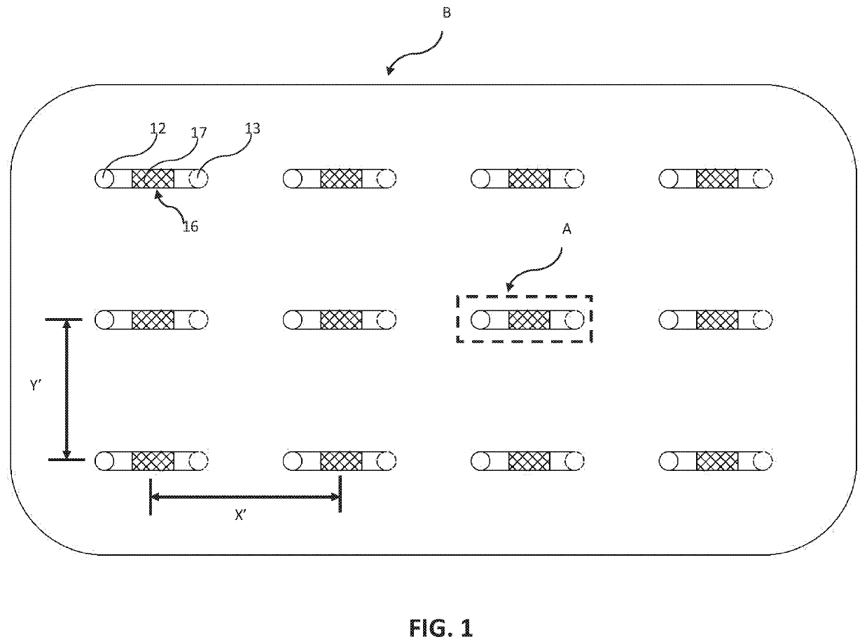

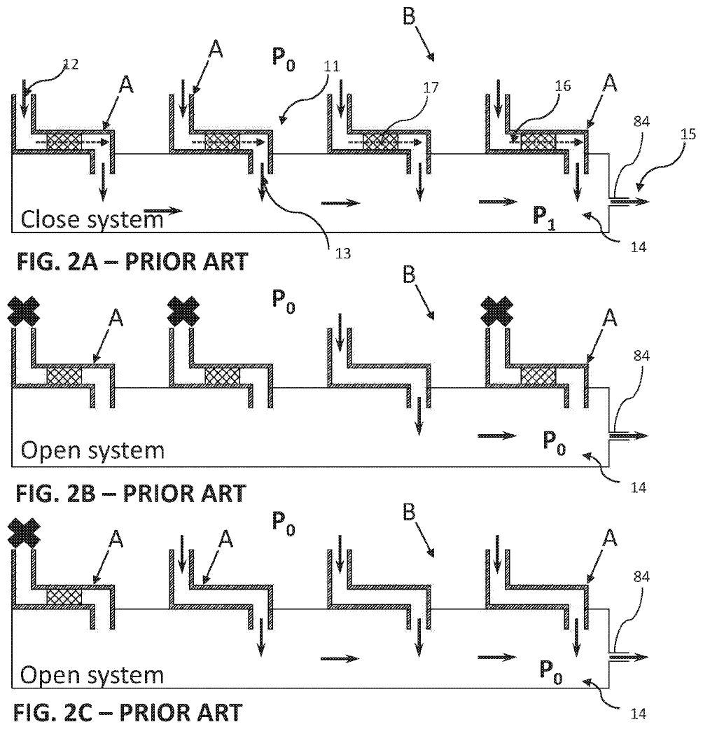

### DETAILED DESCRIPTION OF THE INVENTION

This invention pertains to a method and a related drainage system to address the above problem so that the differential pressure can be maintained between the inlet and outlet regardless of whether there is the liquid plug in each microfluidic unit.

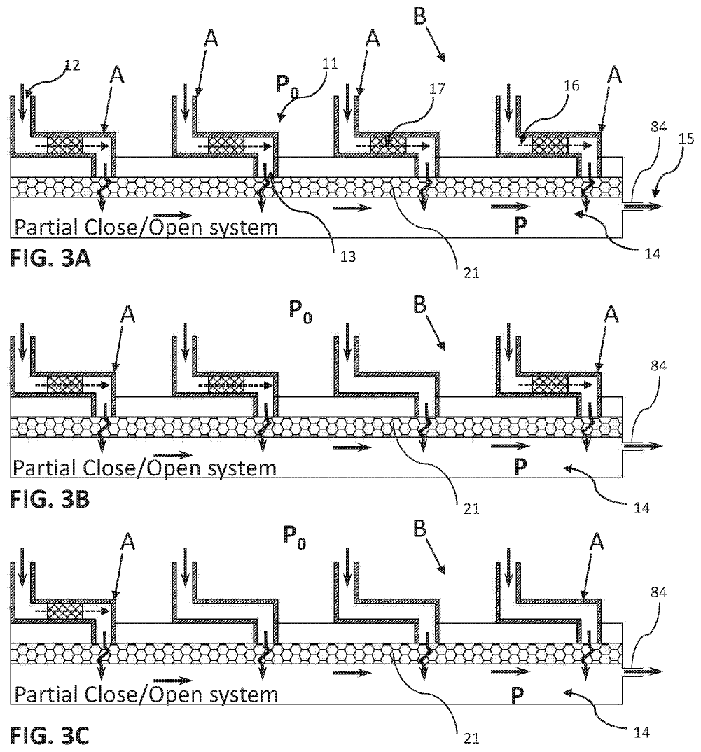

The system and method of this invention is illustrated schematically in FIGS. 3A-C, in which a locally-compressible semipermeable layer 21 is brought into firm contact with the outlets 13 of the one or more microfluidic units A carried on a plate B. The semipermeable layer 21 provides air flow resistance, variable as a function of compression, so that a pressure differential can be selectively established between the several inlets 12 and outlets 13. That is to say, the semipermeable layer 21 is configured to provide pneumatic resistance to air flowing through the microfluidic channel(s) 16. As exemplified in FIG. 3A, when all units A have liquid plugs 17 in their respective microfluidic channels 16, the pressure difference can be maintained and consequently the liquid plug 17 in each channel 16 can be driven through the microfluidic channel 16 toward its outlet 13. In case of the absence of a liquid plug in one (FIG. 3B) or in multiple microfluidic channels 16 (FIG. 3C), the differential pressure can still be maintained so that the liquid plug(s) 17 in the remaining channel(s) 16 will be driven through the respective microfluidic channel(s) 16 toward the respective outlet(s) 13.

The semipermeable layer 21 can be a liquid-absorbent construction so that the expelled liquid plugs 17 are eventually absorbed by this layer 21 until reaching its absorbent capacity. After the absorbent capacity of the semipermeable layer 21 has been reached, continued additions of liquid will cause precipitation that is collected in the plenum chamber bottom 14 below the semipermeable layer 21. Alternatively, the semipermeable layer 21 can be configured as a non-liquid-absorbent element, in which case the drained liquid passes through and is collected directly in the plenum chamber bottom 14.

Thus, FIG. 3 represents a scenario in which the semipermeable layer 21 is placed under the outlets 13 to maintain a beneficial pressure differential by resisting air flow regardless of whether one or multiple channels 16 are open. This semipermeable layer 21 can be liquid-absorbent to withhold the liquid from the outlet, or does not absorb liquid, in which case the liquid is drained to and collected by the plenum chamber under the semipermeable layer 21. FIG. 3A illustrates that liquid plugs 17 concurrently residing in all channels 16 are driven under the differential pressure that is created by connecting the bottom plenum chamber 14 (which is isolated from the ambient surrounding) to a negative pressure or vacuum system 15. FIGS. 3B and 3C illustrate that the differential pressure between the inlets 12 and the outlets 13 can still be maintained to drive the present liquid plugs 17 toward the outlet 13 even when one or multiple channels 16 are open (i.e., no liquid plug 17 is one or more channels 16).

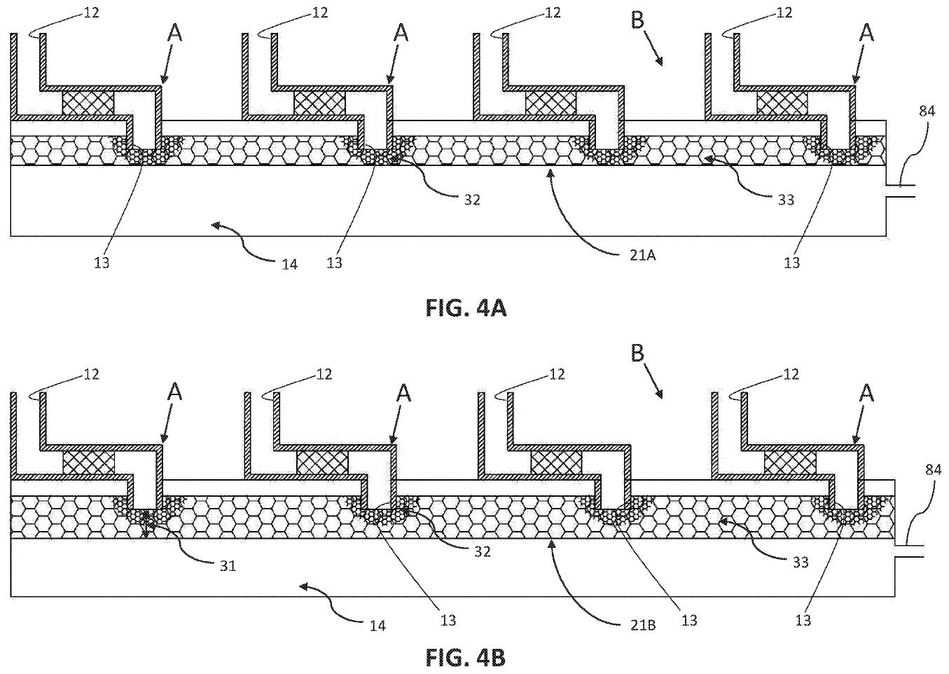

FIGS. 4A and 4B illustrate semipermeable layers 21A, 21B having different thicknesses. In FIG. 4A, a relatively thin semipermeable layer 21A is shown, whereas in FIG. 4B the semipermeable layer 21B is relatively thick. The relative thickness of the semipermeable layer 21A/B affects the distance 31 between the nearby channel outlet 13 and the bottom-most boundary of the semipermeable layer 21A/B. Naturally, a relatively thick semipermeable layer 21B will have a larger distance 31, as depicted in FIG. 4B. The thickness of the semipermeable layer 21A/B may, for example, range between about 0.1 mm to about 25 mm.

In some contemplated embodiments, the semipermeable layer 21A/B is inhomogeneous. That is to say, the semipermeable layer 21 may be designed to have a higher density 32 or some other treatment near the outlets 13 to provide a higher air flow resistance. In this embodiment of an inhomogeneous semipermeable layer 21, a lower density 33 or other treatment may be present in areas away from the outlets 13 to provide a higher liquid absorbent capacity.

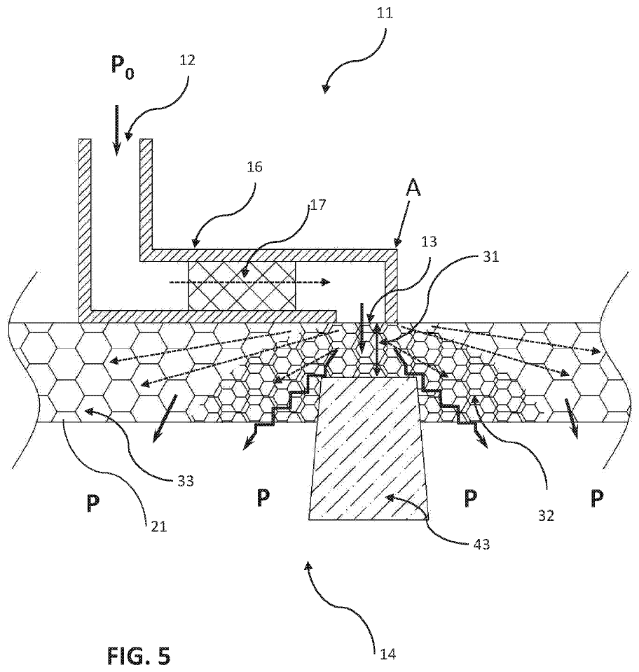

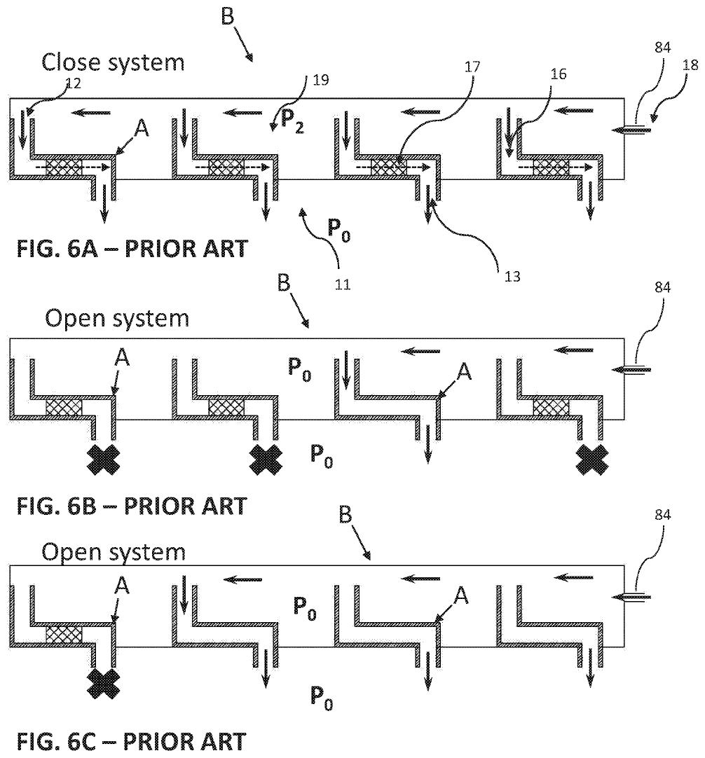

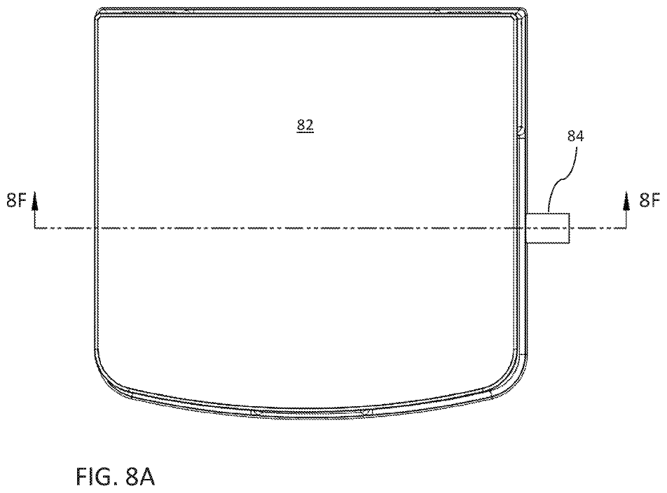

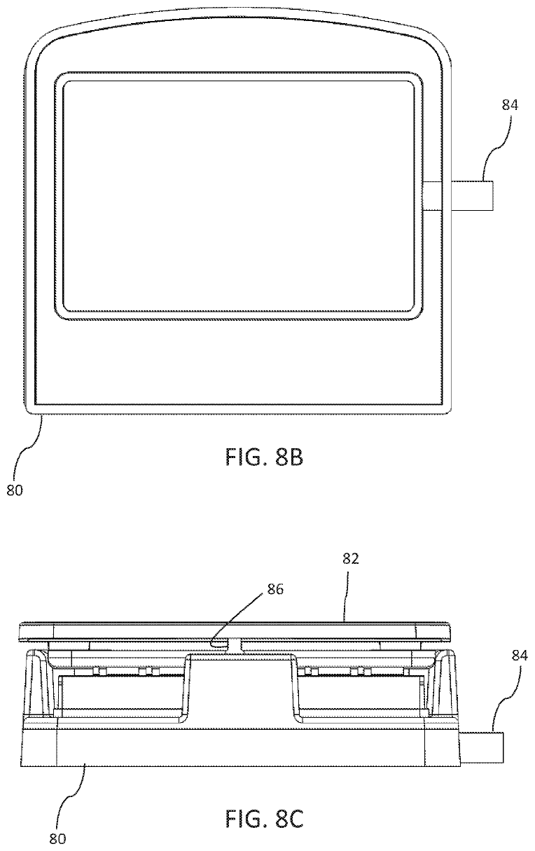

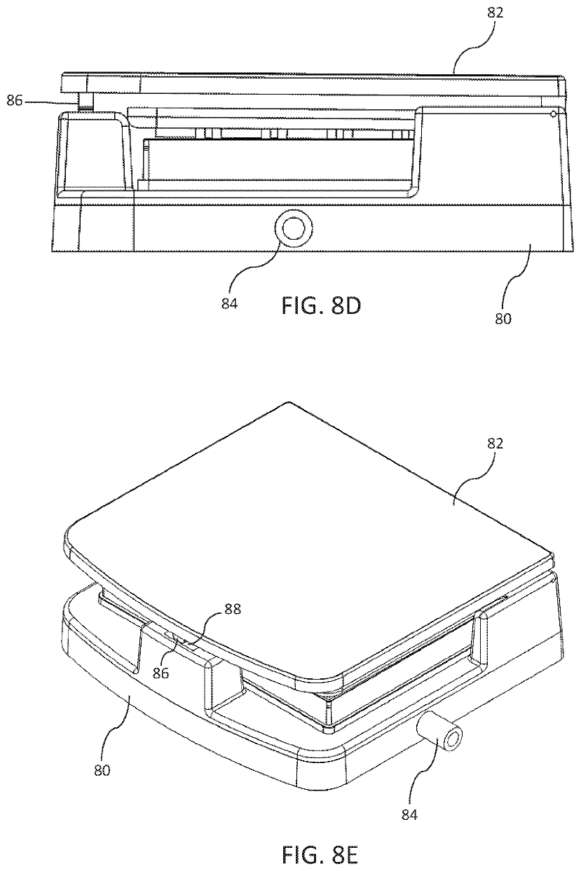

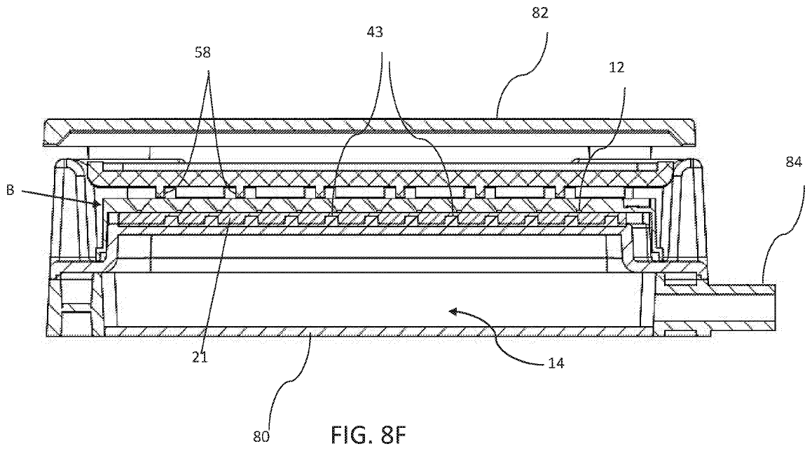

Turning to FIG. 5, another alternative embodiment is shown in which the higher density region 32 of the semipermeable layer 21 can be generated, on demand, in a localized region near the outlet 13, by a post 43. The post 43 may be tapered (i.e., generally conical) or straight (i.e., cylindrical) or domed or any other useful shape. In FIG. 5, the distal end of the post 43 is shown in the form of a truncated tip having a relatively flat surface parallel to the semipermeable layer 21, thus giving the post 43 a generally frustoconical shape. In some contemplated embodiments, the shape of the post tip may be domed (hemispherical) or configured with some other advantageous shape to facilitate its functionality. The tip of the post 43 is located underneath the semipermeable layer 21, aligned directly below the outlet 13. Thus, the semipermeable layer 21 is sandwiched between the outlet 13 and the post 43. With a slight force between the post 43 and the outlet 13, the semipermeable layer 21 is squeezed in the vicinity of the tip to create a higher density region 32 of the semipermeable layer 21 and hence a higher air flow resistance. Desired air flow resistance can be controlled by varying the distance 31 between the top of the post 43 and the outlet 13 of the channel 16. The distance 31 can be established by design, or in some embodiments by manual pressure which could allow on-the-fly modulation of air flow resistance subject to operator manipulation. As shown in FIGS. 8F, 9 and 10B, an array of posts 43 can be used when there is an array of outlets 13 so that regions of higher density 32 can be created in the semipermeable layer 21 under each outlet 13.

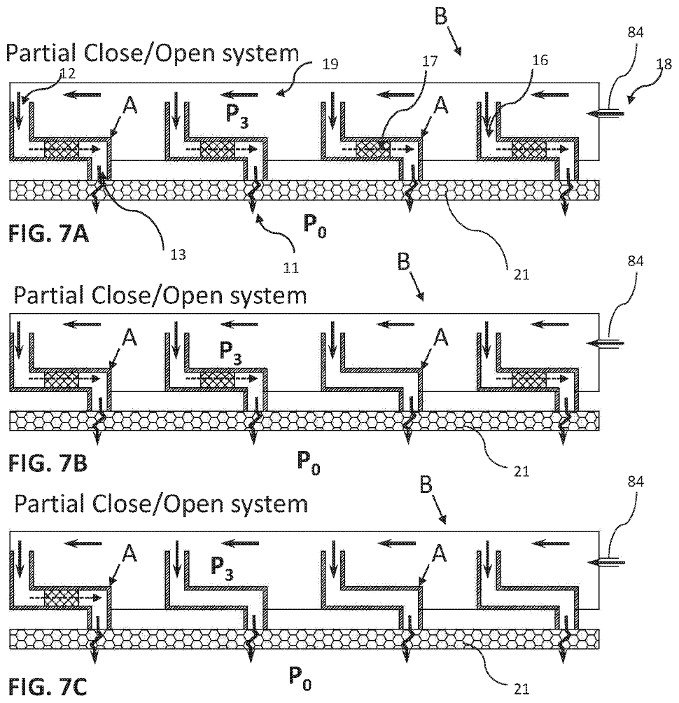

As previously stated, the differential pressure can be generated by lowering the pressure P in a lower or bottom plenum chamber 14 where the outlets 13 reside, or alternatively by increasing the pressure P₀ in a top plenum chamber 19 where the inlets 12 reside. FIGS. 3A-C depict the creation of negative pressure (i.e., vacuum), or lower pressure zone P, in the bottom plenum chamber 14 by connecting the bottom plenum chamber 14 to a vacuum generator 15. FIGS. 7A-C illustrate generation of the differential pressure between the inlet 12 and the outlet 13 by connecting the top plenum chamber 19 (where the inlets 12 reside) to a pressure generator 18. In this latter configuration, the pressure P₃ at the top plenum chamber 19 will be larger than the pressure P₀ of the ambient environment 11 (or lower plenum chamber 14).

In FIGS. 7A-C, the semipermeable layer 21 is placed under the outlets 13 to maintain the differential pressure regardless of whether one or multiple channels 16 are open. The semipermeable layer 21 can be liquid-absorbent to draw liquid away from the outlets 13, or non-absorbent in which case liquid is collected by the plenum chamber 14 under the semipermeable layer 21. FIG. 7A illustrates that liquid plugs 17 in all channels 16 are driven under the differential pressure that is created by connecting the top plenum chamber 19 (which is isolated from the ambient environment or a bottom plenum chamber 14) to a pressure generating system 18. FIGS. 7B and 7C illustrate that the differential pressure between the inlet 12 and the outlet 13 can still be maintained to drive the liquid plug 17 toward the outlet 13 even when one or multiple channels 16 are open (i.e., no liquid plug 17 is present).

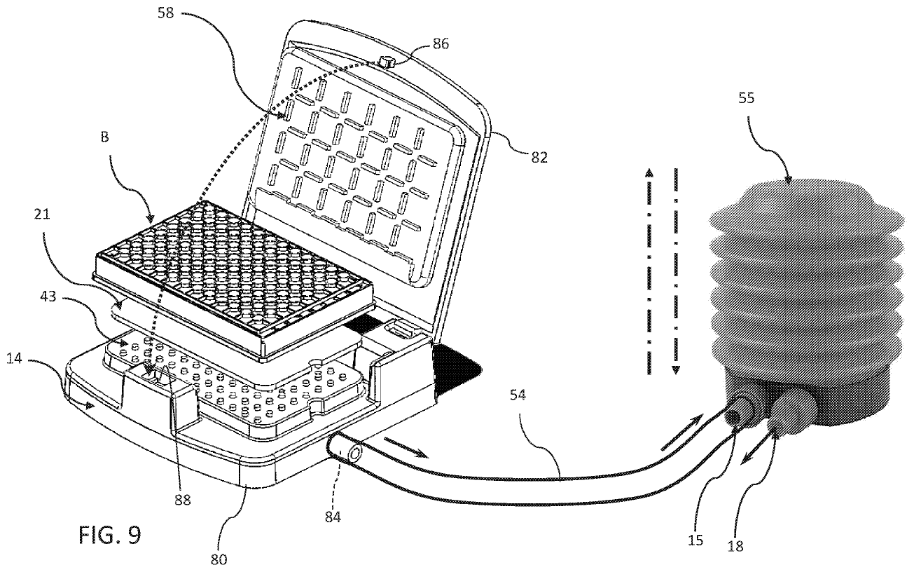

FIGS. 8A-F show several views of an exemplary drainage device according to an embodiment of the invention configured to implement the schematic design of FIGS. 3A-C. The drainage device in these views takes the form of a clam-shell like construction having a base 80 and a hinged lid 82. In all views of FIGS. 8A-F, the lid 82 is shown in a closed condition. A bottom plenum chamber 14 is integrated into the base 80, as best seen in FIG. 8F. A fitting or nipple 84 communicates with the bottom plenum chamber 14 to enable connection of a conduit or hose 54 (FIG. 9).

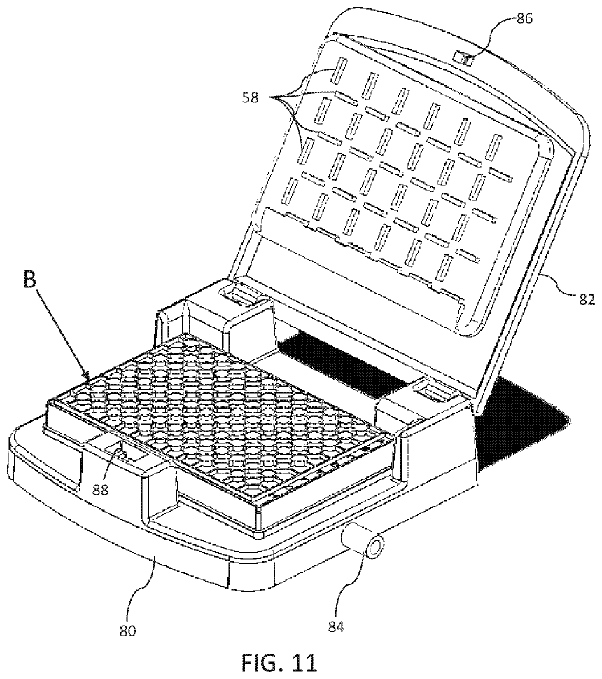

FIG. 9 is a perspective view of the exemplary drainage device of FIGS. 8A-F but showing the lid 82 in an open condition. As can be observed in this figure, the device may be fitted with a latching feature or clasp system. Naturally, such a latching feature can take many different forms. As shown in FIGS. 9 and 11, however, the exemplary latching feature has a male part 86 attached to the swinging edge of the lid 82 and a female or receiving part 88 fitted to the base 80. When the lid 82 is closed (FIG. 8F) the two mating parts 86, 88 interlock to retain the lid 82 in a secure down position.

One end of hose 54 is operatively connected to the fitting 84. The other end of the hose 54 is connected to a pneumatic pump 55. In this example, the pneumatic pump 55 is depicted as a simple, manual bellows device however in practice the pneumatic pump 55 can be any form of device or arrangement that enables the creation of a suitable differential pressure between the inlets 12 and outlets 13 of the one or more microfluidic units A. Returning to the illustrated example, the pneumatic pump 55 includes a vacuum valve fitting 15 and a positive pressure valve fitting 18. These respective fittings 15, 18 correspond to the schematic illustrations of FIGS. 3A-C and 7A-C. By selectively moving the connection of the hose 54 between the fittings 15, 18, either a negative or a positive pressure can be created inside the hose 54 when the pneumatic pump 55 is activated by compressing the bellows. In FIG. 9, the hose 54 is shown attached to the vacuum valve fitting 15 because the clam-shell device in this example is configured with a bottom plenum chamber 14 as per the schematics of FIGS. 3A-C. In another example (not shown), the device may be configured with a top plenum chamber 19 in which case the hose 54 would instead be attached to the positive pressure valve fitting 18.

FIG. 9 also shows an exemplary microfluidic 96-well plate B in exploded view fashion together with an exemplary semipermeable layer 21 poised between the plate B and an array of posts 52 extending like stalagmites from an elevated receiving table in the base 80. Preferably, the posts 43 are all aligned with respective outlets of the plate B. As clearly visible in this view, the interior surface of the lid 82 may be configured with an array of load distribution elements 58. The load distribution elements 58 serve to lock the microfluidic array unit B and the semipermeable layer 21 in position within the device so that the posts 52 will properly align with the outlets 13 and so that downward pressure is more evenly distributed through the sandwiched components when the lid 82 is closed.

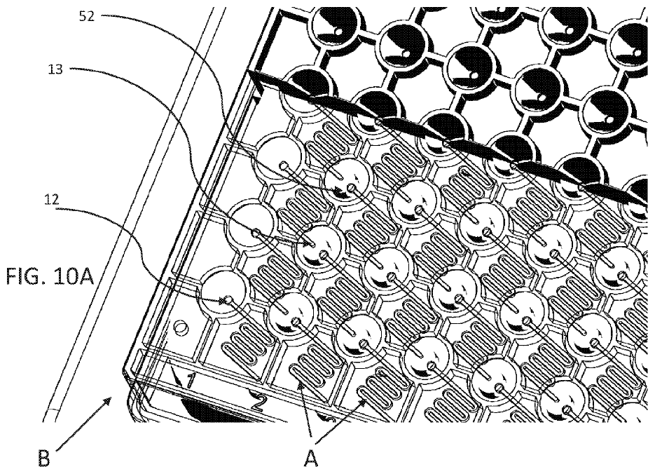

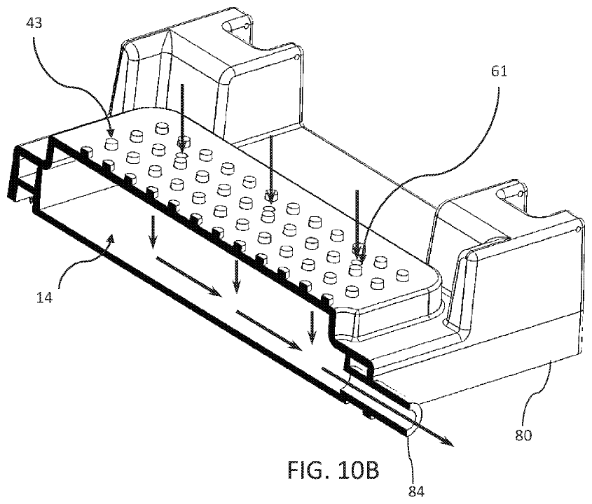

FIG. 10A is an enlarged fragmentary view of one exemplary style of plate B that can be used in the drainage system and method of this invention. The plate B is shown supporting multiple microfluidic units A each having a serpentine microfluidic channel 16 extending between a respective inlet 12 and outlet 13. The exemplary plate B shown here is a microfluidic 96-well plate designed by Optofluidic Bioassay, LLC of Ann Arbor, Mich. under the trademark MicroFluere®. While test data has shown that the MicroFluere® product is particularly well-suited for use in the drainage system and method of this invention, it is expected that plates B of other styles and from other manufacturers are likely to perform satisfactorily in the present drainage system and method also.

FIG. 10B is a cross-sectional view taken transversely through the base 80 of a drainage device like that shown in FIG. 8E. The section line passes through the bottom plenum chamber 14 and cuts axially along the fitting 84. In the elevated receiving table are shown the upwardly-extending array of posts 43. The posts 43 are aligned to the outlets 13 of a microfluidic plate (not shown). The plate B can be like those shown in FIGS. 9 and 10A. A plurality of air holes 61 are disposed strategically through the top, adjacent the posts 43. The air holes 61 provide air circulation paths leading into the bottom plenum chamber 14 as represented by directional arrows that ultimately exit through the fitting 84.

FIG. 11 is a perspective view as in FIG. 9 but with an exemplary plate B and semipermeable layer 21 disposed in operative positions upon the base 80. In this view, the lid 82 open, the load distribution elements 58 inside the lid 82 are clearly visible as a rectilinear arrangement of ribs. Naturally, the drainage device can take many different forms within the spirit and scope of this invention.

This invention comprises a method and a drainage system to create and maintain the differential pressure between the inlet 12 and the outlet 13 in multiple independent microfluidic units A on a single microfluidic device B, in order to drive the liquid plug 17 in microfluidic units A toward their respective outlets 13 regardless whether one or multiple microfluidic units A are open. The drainage system includes the aforementioned semipermeable layer 21 having some or all of the mentioned attributes. In some embodiments, the pneumatic resistance to air flowing through the microfluidic channel(s) 16 can be varied by either altering the compression applied to the semipermeable layer 21 (as in FIG. 5) or altering the regional density of the semipermeable layer 21 (as in FIGS. 4A-B) or both. It should further be understood that invention is not constrained by the nature and design of the negative (vacuum) and/or positive pressure generating system, or any other such ancillary or peripheral features. Additionally, it is contemplated that the negative and/or positive pressure generating system may be connected to one or more sub-chambers, in each of which serve only a fraction of the outlets 13.

The method provides a simple way to drive the liquid plugs 17 in multiple independent microfluidic units A (and channel 16) toward their respective outlets 13 by differential pressure between the inlet 12 and the outlet 13 that is generated by only one vacuum system connected to the bottom plenum chamber 14 or only one pressure generating system connected to the top plenum chamber 19.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A drainage system for prompting movement of at least one liquid plug through a microfluidic channel toward an outlet, said system comprising:
a base, a lid operatively connected to said base, a plenum chamber associated with one of said base and lid, and
a semipermeable layer disposed between said base and said lid, said semipermeable layer configured to provide pneumatic resistance to air flowing through the microfluidic channel.

2. The system of claim 1 wherein the pneumatic resistance is variable as a function of compression to thereby selectively establish a pressure differential.

3. The system of claim 1 wherein said semipermeable layer has thickness between about 0.1 mm and 25 mm.

4. The system of claim 1 wherein said semipermeable layer includes at least one dense porous region surrounded by a loose porous region.

5. The system of claim 1 wherein said semipermeable layer includes a plurality of dense porous regions surrounded by loose porous regions.

6. The system of claim 1 wherein said semipermeable layer is absorbent.

7. The system of claim 1 wherein said semipermeable layer is non-absorbent.

8. The system of claim 1 wherein said base has an elevated receiving table, at least one post extending upwardly from said receiving table.

9. The system of claim 1 wherein said base has an elevated receiving table, a plurality of posts extending upwardly from said receiving table.

10. The system of claim 9 wherein each said post includes a tip, said semipermeable layer being arranged relative to said posts to create localized dense porous regions in the vicinity of said tip of each said post.

11. The system of claim 9 wherein each said post has a truncated tip.

12. The system of claim 1 wherein said lid includes a plurality of load distribution elements.

13. The system of claim 12 wherein said load distribution elements comprising a rectilinear arrangement of ribs.

14. A drainage system for prompting movement of at least one liquid plug through a microfluidic channel toward an outlet, said system comprising:
a base, a lid hingedly connected to said base for swinging movement between opened and closed positions, a plenum chamber associated with one of said base and lid, a fitting extending from said plenum chamber,
a hose attached to said fitting, a pneumatic pump operatively connected to said hose for generating at least one of a negative and a positive pressure in said hose, and
a semipermeable layer disposed between said base and said lid, said semipermeable layer configured to provide pneumatic resistance to air flowing through the microfluidic channel.

15. The system of claim 14 wherein said base has an elevated receiving table, a plurality of posts extending upwardly from said receiving table.

16. The system of claim 15 wherein each said post includes a tip, said semipermeable layer being arranged relative to said posts to create localized dense porous regions in the vicinity of said tip of each said post.

17. The system of claim 14 wherein said semipermeable layer includes a plurality of dense porous regions surrounded by loose porous regions.

18. A method for draining a microfluidic device comprising the steps of:
positioning a microfluidic well plate on a receiving table, the plate having at least one microfluidic unit, the unit including an inlet and outlet and a microfluidic channel extending between the respective inlet and outlet,
generating a pressure differential in a plenum chamber located with respect to one of the inlet and outlet of the microfluidic unit, and
pressing a semipermeable layer against the outlet to provide pneumatic resistance to air flowing through the microfluidic channel.

19. The method of claim 18 wherein said pressing step includes concentrating the pressure with the truncated tip of a post.

20. The method of claim 18 further including the step of varying the pneumatic resistance to air flowing through the microfluidic channel as a function of at least one of compression and regional density.
